(19) United States
(12) Patent Application Publication
(10) Pub. No.: US 2005/0285059 A1
(43) Pub. Date: Dec. 29, 2005

(54) Apparatus and a method for detecting flatness defects of a web moving over a roller assembly

(76) Inventors: Terry Lee Gerber, Lisbon, OH (US); Peter David Spooner, Hampshire (GB)

Correspondence Address: NOTARO AND MICHALOS, 100 DUTCH HILL ROAD, SUITE 110, ORANGEBURG, NY, 10962-2100, US

(21) Appl. No.: 10/876,195

(22) Filed: Jun. 24, 2004

(51) Int. Cl. G01N 21/88

(52) U.S. Cl. 250/559.45

(57) ABSTRACT

An apparatus (1) used for detecting flatness defects of a web (2) comprises a rotatable roller bearing assembly (4) comprising a roller unit (6) mounted on a central arbor (8), a light carrying medium (11) that extends through the roller bearing assembly (4), a light source (10) for transmitting a light signal through the light carrying medium (11), and optical sensing means (12) for measuring strain forces in the roller unit (6) caused by the web (2) passing over the roller unit (6). The optical sensing means (10) is in optical communication with the light carrying medium (11) and is disposed along a portion of the longitudinal length of the roller unit (6). Means are provided for receiving and analysing the light signal that has passed through the light carrying medium (11).

The present invention relates to apparatus and a method for detecting flatness defects of a web moving over a roller assembly, and is concerned particularly with apparatus and a method using optical sensors for detecting flatness defects of a web moving over a roller assembly.

In the production of web materials, such as metals, paper, plastics, etc. it is common practice to determine the flatness of the final material by measuring the variation of the stress and hence the strain during production. The methods currently available for making this measurement consist of passing the web material over a roll with a small wrap angle. Integrated in the roll is means for measuring the force applied by the web at different points across the width. The force applied is a function of the wrap angle and the stress in the web, the variation in the measured force therefore indicates the variation in the strain and hence the flatness of the material.

A known roller air bearing assembly for detecting flatness defects in a continuously running web comprises an array of annular rotors mounted coaxially on a central stationary arbor. The central arbor is formed with a series of radially extending fluid ports, which provide the array of annular rotors with an air film. In use the air film holds the rotors spaced from the arbor and forms a radial pneumatic bearing on which the rotors rotate. The arrangement of the rotors is such that there may be a radial air gap between neighbouring rotors. The web material, typically a thin sheet metal, is passed over and supported by the rotors such that any transverse strain variation in the web material produces a variation of forces on the individual rotors. The force on each rotor is detected by a set of electrical transducers that detect the differential pressure of the air film between the top and the bottom of the air bearing supporting the rotor. The electrical transducers are disposed at the surface of the arbor. Such a device is presently manufactured by Shape Technology Ltd and is known as an air bearing shapemeter. These existing instruments for making the measurement of the variation of the transverse strain consist of an array of annular rotors positioned on a central stationary arbor such that there is a broken surface resulting from the measurement technique used. The arbor has a series of electrical transducers disposed thereon that detect radial movement of respective rotors relative to the arbor. For some known roller assemblies the transducers are disposed distant from the surface of the arbor. In most cases it is critical that the web material being produced has a very high quality surface finish and there is always the risk of surface marking if the surface of the roll is broken. Also, there is no means currently available which allows the strain and the temperature to be measured simultaneously.

According to a first aspect of the present invention there is provided apparatus used for detecting flatness defects of a web, the apparatus comprising a rotatable roller bearing assembly comprising a roller unit mounted on a central arbor, a light carrying medium that extends through the roller bearing assembly, a light source for transmitting a light signal through the light carrying medium, optical sensing means for measuring strain forces in the roller unit caused by the web passing over the roller unit, the optical sensing means being in optical communication with the light carrying medium and being disposed along a portion of the longitudinal length of the roller unit, and means for receiving and analysing the light signal that has passed through the light carrying medium.

Preferably, the optical sensing means is also for measuring the heat energy of the roller unit caused by the web passing over the roller unit.

Analysed elements of the light signal that has passed through the light carrying medium via the optical sensing means provide information about the strain forces and the heat energy in the roller unit caused by the web passing over the roller unit. The variation in stresses and temperature along the roller indicates a variation in stress across the web and hence the flatness of the web.

Preferably, the optical sensing means comprises a plurality of optical sensors disposed along the longitudinal length of the roller unit, the arrangement being such that in use each optical sensor detects the strain force of a portion of the roller unit.

In a first embodiment of the present invention, the light carrying medium that extends through the roller bearing assembly defines a single optical path, the optical sensing means being disposed along a portion of the optical path.

Preferably, the optical sensing means comprises a plurality of optical sensors disposed at discrete regions along the single optical path.

Preferably, the optical sensors are formed on separate regions of the light carrying medium.

The light carrying medium is preferably a fibre optic cable.

The optical sensors are preferably fibre bragg gratings.

In a second embodiment of the present invention the apparatus comprises means for splitting a light signal from the light source into a plurality of signals, a plurality of light carrying medium for transmitting the respective light signals through the roller unit, a plurality of optical sensors, and means for receiving and analysing the respective light signals that have passed through the light carrying medium, the arrangement being such that respective optical sensors are disposed on each light carrying medium.

The roller unit is preferably a tubular section formed with a substantially smooth cylindrical radially outermost bearing surface.

Alternatively, the outermost bearing surface of the tubular section is formed with a non-smooth surface for improved gripping properties.

Preferably, the tubular section comprises internal regions of reinforcement separated by regions capable of greater radial deflection than the regions of reinforcement, the optical sensors being disposed in the regions capable of greater radial deflection between the regions of reinforcement, the arrangement being such that in use the optical sensors detect the strain forces in the regions capable of greater radial deflection caused by the web passing over the tubular section.

The internal regions of reinforcement are preferably annular sections disposed coaxially with the longitudinal axis of the roller bearing assembly.

Alternatively, the roller unit is a roller air bearing assembly comprising an array of annular rotors each rotatably mounted on the arbor, the arrangement being such that, in use, there is a air film disposed radially between the annular rotors and the arbor.

Preferably, the abor comprises a plurality of optical sensors, each sensor being disposed adjacent the radially inner surface of a rotor at a point along the longitudinal length of the respective rotor.

According to a second aspect of the present invention there is provided a method for detecting flatness defects of a web moving over a roller assembly, the method comprising generating an optical signal, transmitting the optical signal to optical sensor means disposed within the roller assembly and analysing the optical signal from the optical sensor.

Analysed elements of the optical signal that has passed via the optical sensing means may provide information about the strain forces and the heat energy in the roller unit caused by the web passing over the roller unit. The variation in stresses and temperature along the roller indicates a variation in stress across the web and hence the flatness of the web.

The invention may include any combination of the features or limitations referred to herein.

The present invention may be carried into practice in various ways, but some assemblies will now be described, by way of example only, with reference to the accompanying drawings in which:

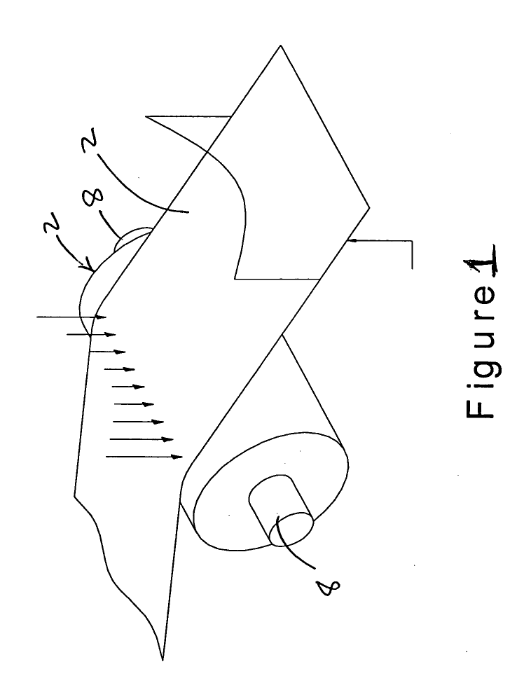

FIG. 1 shows an isometric view of an apparatus for detecting flatness defects of a web moving over a rotatable roller bearing assembly according to the present invention;

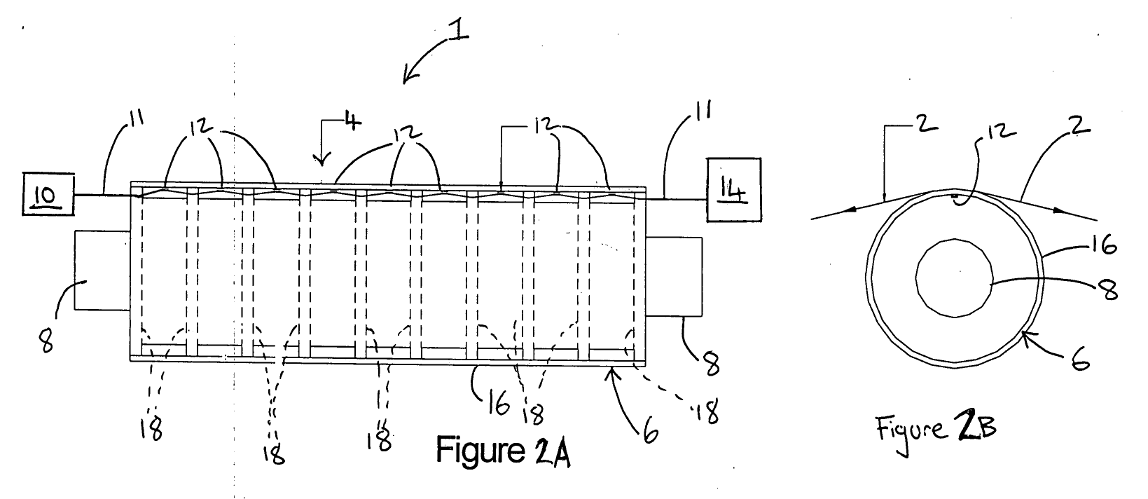

FIG. 2A shows a side view of a first example of an apparatus for detecting flatness defects of a web moving over a rotatable roller bearing assembly according to the present invention;

FIG. 2B shows a view in direction along the axis of the apparatus and web shown in FIG. 2A;

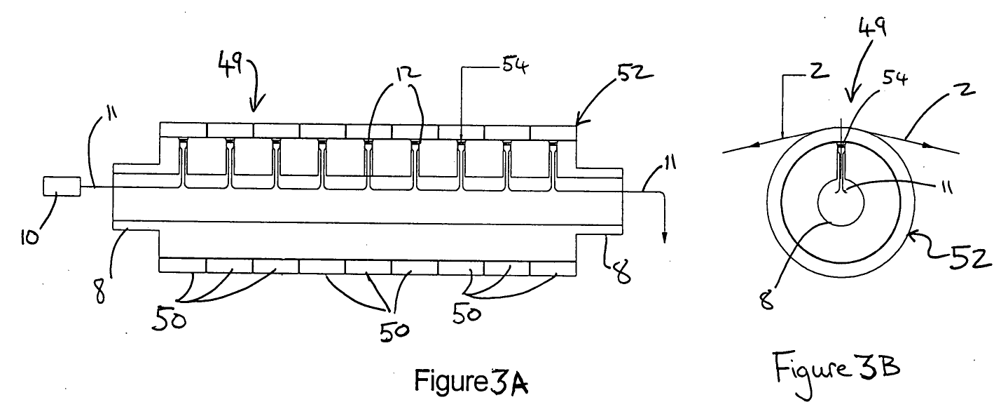

FIG. 3A shows a side view of a second example of an apparatus for detecting flatness defects of a web moving over a rotatable roller bearing assembly according to the present invention;

FIG. 3B shows a view in direction along the axis of the apparatus shown in FIG. 3A;

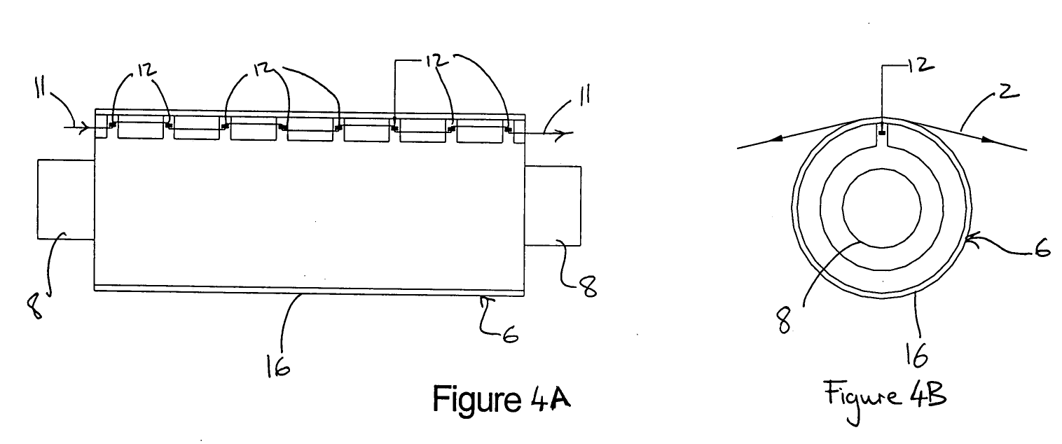

FIG. 4A shows a side view of a third example of an apparatus for detecting flatness defects of a web moving over a rotatable roller bearing assembly according to the present invention;

FIG. 4B shows a view in direction along the axis of the apparatus shown in FIG. 4A;

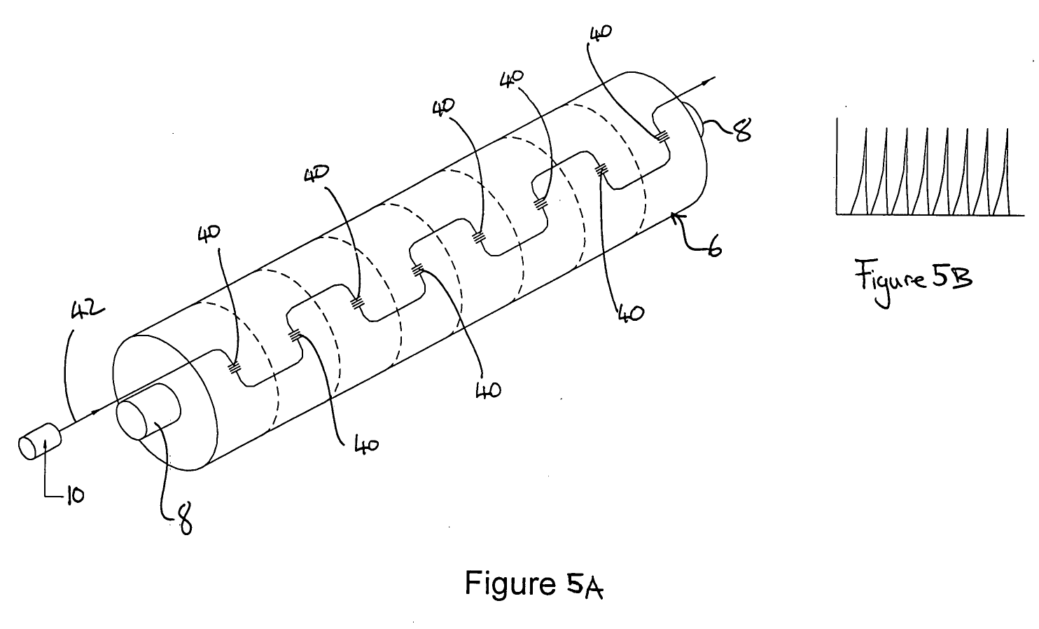

FIG. 5A shows an isometric view of an apparatus for detecting flatness defects of a web moving over a rotatable roller bearing assembly according to the first embodiment of the present invention;

FIG. 5B shows a graph of an optical signal generated by the apparatus shown in FIG. 5A; and

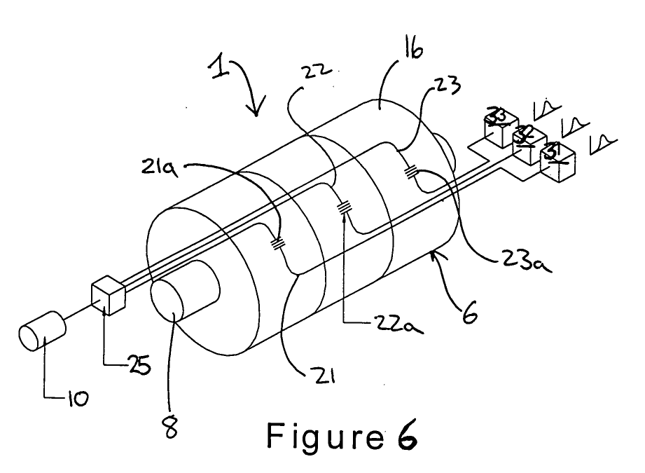

FIG. 6 shows an isometric view of an apparatus for detecting flatness defects of a web moving over a rotatable roller bearing assembly according to the second embodiment of the present invention.

With reference to FIGS. 1, 2A and 2B, apparatus 1 for detecting flatness defects of a web 2 that passes over the apparatus 1 comprises a roller bearing assembly 4 comprising a cylindrical roller unit 6 rotatably mounted on a stationary central arbor 8. In an alternative embodiment of the present invention the cylindrical roller unit and the arbor are both rotatable. A light source 10 is provided for transmitting a light signal through a fibre optic cable 11 that extends through the roller bearing assembly 4. A plurality of optical sensors 12 are disposed along a portion of the longitudinal length of the roller bearing assembly 4 for measuring strain forces in the roller unit 6 caused by the web 2 passing over the roller unit 6. The optical sensors 12 are in optical communication with the fibre optic cable 11. The fibre optic cable 11 extends through the assembly 4 and connects with means 14 a light frequency demodulation/interrogation unit for receiving and analysing the light signal that has passed through fibre optic cable 11 via the optical sensors 12.

The cylindrical roller unit 6 comprises a tubular sleeve 16 formed with a continuous radially outermost surface and a plurality of annular support members 18 disposed within the sleeve 16 axially separated from each other. The radially outermost surface of the tubular sleeve 16 may be smooth or alternatively have a rough texture in order to provide improved gripping properties. The annular support members 18 are rotatably mounted on the central arbor 8 such that the sleeve 16 is only supported at a series of individual regions along the longitudinal axis of the roller unit 6. Each optical sensor 12 is disposed along a portion of unsupported section of the sleeve 16 between a pair of respective annular support members 18. As the web material 2 passes over the roller unit 6 the unsupported sections of the sleeve 16 axially between the annular support members 18 will deflect depending on the force applied thereto.

The deflection of the unsupported sections along the sleeve 16 is detected using a optical sensors 12. Specifically the change in the physical dimension of the optical sensors 12 when passing under the web can be used to interpret strain and the change in physical dimension of the optical sensor 12 at a second rotational position when not deflected by the web can be used to interpret temperature information in the roller unit 6. The strain and temperature information can be gathered as changes in amplitude, phase, or frequency of a reference light signal away from an ambient strain or temperature reference point.

Although changes in amplitude, phase, or frequency can be used, the most convenient is to measure changes in frequency/wavelength of a transmitted light source. A frequency change optical sensor makes use of technology developed for the telecommunications industry in dense wavelength multiplexing (DWDM) for voice and data transmission on a single fibre optic cable. Hence the variation in the deflection of the sections along the roller unit 6 will indicate the variation in stress across the web 2 and hence the flatness of the web 2.

If a web material 2 is placed under sufficient tension, any variation in strain and hence flatness will be transformed into a variation in stress and the web 2 will appear flat. If the tensioned web 2 is then passed over a roller unit 6, as shown in FIG. 2, the force applied to the roller unit 6 along its length will vary according to the variation in stress across the web 2. If the roller bearing assembly is designed such that unsupported sections along the length of the roller unit 6 deflect according to the force applied to each, then measurement of those deflections will indicate the variation in stress across the web 2 and hence the flatness of the web 2.

The flatness of the final web material 2 may be different to that measured during production if there is a non-uniform transverse temperature in the web 2 when it is measured. This non-uniform temperature profile will disappear as the material cools causing a variation in contraction and hence changes in flatness. To accurately determine the final flatness therefore it is necessary to measure the transverse temperature and the transverse stress profile simultaneously.

One optical sensor device that we have found may be used for measuring strain and temperature in a fibre optic waveguide is a Fibre Bragg Grating (FBG). An FBG is essentially a series of mirrors imprinted in an iridium doped fibre optic cable at precisely spaced length intervals along the cable. The mirrors are imprinted by subjecting the fibre optic cable to an impulse of light from an Eximer laser through slits in a precise phase mask. At a particular light wavelength the imprinted mirrors exhibit their maximum reflectivity. This point of maximum reflectivity is called the Bragg wavelength. As the fibre optic cable is stretched or compressed, the reflected wavelength is changed. By monitoring these changes with the appropriate demodulating techniques, a high resolution, accurate, and linear translation of strain and/or temperature can be measured.

With reference to FIGS. 3A and 3B, a second example of the present invention comprises a fibre optic strain detection assembly that is placed into an air-bearing shapemeter 49. The air-bearing shapemeter 49 comprises an array of separate annular rotors 50 that form the roller unit 52. A known method of detecting flatness defects of the web 2 would be to monitor the variation of stress across a web 2 as it passes over such a roller unit 52 by the changes in the differential pressure at the top and the bottom of each annular rotor 50 of the roller unit 52. The present invention uses mounted diaphragms in the top of the arbor at the centre of each rotor 50 and a respective sensor element 54 disposed on the diaphragm. The sensor element 54 forms part of a FBG optical sensor 12. The changes in pressure are detected from changes in the deflection of the diaphragms measured by FBG optical sensors 12 in a fibre optic waveguide.

With reference to FIGS. 4A and 4B, a third example of the present invention comprises a rotatable roller bearing assembly wherein the fibre optic sensors 12 are placed at a position that allows the measurement of strain in a compressible piece that is in contact with the deformable shell, thus producing a fibre optic load cell for indirectly measuring the strip stress.

With reference to FIGS. 5A and 5B, a rotatable roller bearing assembly according to the first embodiment of the present invention comprises an assembly 1 wherein the optical sensing means comprises a single fibre optic cable 42 and a plurality of sensors 40, that comprise imprinted multiple FBGs with different bragg wavelengths, disposed along the fibre optic cable 42. Using known techniques for demodulating/de-multiplexing these wavelengths, enables one fibre optic cable 40 to measure strain and/or temperature in multiple zones of the roller unit 6.

With reference to FIG. 6, a rotatable roller bearing assembly according to the second embodiment of the present invention comprises a roller unit 6 wherein the optical sensing means comprises a plurality of fibre optic cables 21, 22, 23. Each deformable unsupported section of the sleeve 16 surface is monitored with the individual fibre optic cables 21, 22, 23, each of which contains a respective FBG optical sensor 21a, 22a, 23a. The light source 10 transmits a light signal through signal splitter 25 that in turn transmits the respective signals to each fibre optic cable 21, 22, 23. The signals are transmitted from the respective FBG optical sensors 21a, 22a, 23a to individual demodulating circuitry 31, 32, 33 and then to the analysing means (not shown).

The skilled person in the art should also appreciate that the three examples of a rotatable roller bearing assembly described above with reference to the respective drawings may comprise a single fibre optic cable according to the first embodiment of the present invention. Alternatively, the three examples of a rotatable roller bearing assembly described above may comprise a plurality of fibre optic cables according to the second embodiment of the present invention

The skilled person in the art should also appreciate that it is possible to incorporate the fibre optic strain detection into a segmented solid shapemeter roll such as the ABB Stressometer, the BFI shape roll, or the Clecim Planicim roll, and to replace the load sensing mechanism in these rolls with a fibre optic strain sensor. In the case of the ABB Stressometer, the fibre optic strain sensor would replace the magnetostrictive load cells that are placed at 90 degree intervals under each individual segmented measurement zone around the roll circumference. In the case of the BFI shape roll, the fibre optic strain sensor would replace the piezoelectric force transducers in each individual load zone. Lastly, in the case of the Clecim Planicim shape roll, the fibre optic sensor would replace the position transducers that measure the shell deflection in each load zone.

1. An apparatus used for detecting flatness defects of a web, the apparatus comprising a rotatable roller bearing assembly comprising a roller unit mounted on a central arbor, a light carrying medium that extends through the roller bearing assembly, a light source for transmitting a light signal through the light carrying medium, optical sensing means for measuring strain forces in the roller unit caused by the web passing over the roller unit, the optical sensing means being in optical communication with the light carrying medium and being disposed along a portion of the longitudinal length of the roller unit, and means for receiving and analysing the light signal that has passed through the light carrying medium, wherein the optical sensing means comprises at least one fibre bragg grating.

2. The apparatus of claim 1 wherein the optical sensing means is also for measuring the heat energy of the roller unit caused by the web passing over the roller unit.

3. The apparatus of claim 1 wherein the optical sensing means comprises a plurality of optical sensors disposed along the longitudinal length of the roller unit, the arrangement being such that in use each optical sensor detects the strain force of a portion of the roller unit.

4. The apparatus of claim 1 wherein the light carrying medium that extends through the roller bearing assembly defines a single optical path, the optical sensing means being disposed along a portion of the optical path.

5. The apparatus of claim 4 wherein the optical sensing means comprises a plurality of optical sensors disposed at discrete regions along the single optical path.

6. The apparatus of claim 5 wherein the optical sensors are formed on separate regions of the light carrying medium.

7. The apparatus of claim 1 wherein the light carrying medium is a fibre optic cable.

8. The apparatus of claim 1 wherein the apparatus comprises means for splitting a light signal from the light source into a plurality of signals, a plurality of light carrying medium for transmitting the respective light signals through the roller unit, a plurality of optical sensors, and means for receiving and analysing the respective light signals that have passed through the light carrying medium, the arrangement being such that respective optical sensors are disposed on each light carrying medium.

9. The apparatus of claim 8 wherein the roller unit is a tubular section formed with a substantially smooth cylindrical radially outermost bearing surface.

10. The apparatus of claim 8 wherein the roller unit is a tubular section formed with a non-smooth radially outermost bearing surface for improved gripping properties.

11. The apparatus of claim 9 wherein the tubular section comprises internal regions of reinforcement separated by regions capable of greater radial deflection than the regions of reinforcement, the optical sensors being disposed in the regions capable of greater radial deflection between the regions of reinforcement, the arrangement being such that in use the optical sensors detect the strain forces in the regions capable of greater radial deflection caused by the web passing over the tubular section.

12. The apparatus of claim 11 wherein the internal regions of reinforcement are annular sections disposed coaxially with the longitudinal axis of the roller bearing assembly.

13. The apparatus of claim 8 wherein the roller unit is a roller air bearing assembly comprising an array of annular rotors each rotatably mounted on the arbor, the arrangement being such that, in use, there is a air film disposed radially between the annular rotors and the arbor.

14. The apparatus of claim 13 wherein the arbor comprises a plurality of optical sensors, each sensor being disposed adjacent the radially inner surface of a rotor at a point along the longitudinal length of the respective rotor.

15. A method for detecting flatness defects of a web moving over a roller assembly, the method comprising generating an optical signal, transmitting the optical signal to optical sensor means comprising at least one fibre bragg grating disposed within the roller assembly and analysing the optical signal from the fibre bragg grating.
